(19) United States
(12) Patent Application Publication
(10) Pub. No.: US 2002/0178120 A1
(43) Pub. Date: Nov. 28, 2002

(54) Contract generation and administration system

(76) Inventors: Zachariah J. Reid, Pearland, TX (US); Lucia T. Akers, Bellaire, TX (US); Alan M. Braaten, Baton Rouge, LA (US); James Ronald Clark, Kingwood, TX (US); John F. Hunt, Humble, TX (US); Daniel R. Schuessler, Katy, TX (US)

Correspondence Address: ExxonMobil Chemical Company, P.O. Box 2149, Baytown, TX, 77522-2149, US

(21) Appl. No.: 09/862,626

(22) Filed: May 22, 2001

(51) Int. Cl. G06F 17/60

(52) U.S. Cl. 705/59

(57) ABSTRACT

A contract generation and administration system and method are provided. The system and method include a database for storing detailed data relating to draft and finalized contracts. The database is used to track pending and executed agreements, and to track manage specific agreement obligations and obligation triggering events to ensure that each agreement obligation is met. The system is capable of managing detailed agreements and numerous obligation types including financial and non-financial obligations. The system may also be used to generate correspondence and invoices as are necessary to meet various agreement obligations.

### FIELD OF THE INVENTION

This invention pertains generally to systems and methods for generating and administering contracts using a single database. More specifically, the database enables the user to create and track the progress of draft contracts, to docket and administer contract obligations, obligation triggering events and expiration dates, and to generate reports, form correspondence and invoices as needed to manage a variety of agreement obligations.

### BACKGROUND OF THE INVENTION

Contracts provide the legal framework for conducting business. Many businesses today, particularly large corporations, are party to hundreds, perhaps thousands, of contracts, each, by definition, granting various rights and creating various obligations. Keeping track of the mere existence of every contract, and ensuring compliance with the various rights and obligations they create, presents an enormous challenge.

Other problems arise during contract drafting and negotiation. Even simple contracts often go through a number of drafts before agreement is reached. The process of negotiation and document review and approval, both among and between parties, to a proposed contract is often a complex process during which it is difficult to keep track of various draft versions and approvals.

Computer systems, networks and databases have been created to meet some of these challenges. These products, however, typically address problems associated with one particular area of a contract's lifecycle. For example, U.S. Pat. No. 6,067,531 describes a computer system for automating the negotiation and generation of a contract, but this system fails to address the considerable challenge of managing compliance with multiple contracts once they are generated. On the other hand, there are now a handful of companies who provide software for managing various aspects of contract compliance, but these do not address all of the management and administration needs that arise during the entire lifecycle of a contract, i.e., from the first draft to termination of all rights and obligations. Some of these products allow one to docket obligation due dates, but they do not provide a means for tracking obligation triggering events.

### SUMMARY OF THE INVENTION

The present invention provides a contract generation and administration system for the entire lifecycle of a contract. This system employs a single contract database comprising data obtained from multiple contract documents, said data organized into fields comprising: draft contract status, contract identifier, contract type, effective date, and expiration date; and a field comprising obligation type, owner, status or due date; said system capable of generating reports based on said database, said reports obtainable through search of said fields and said database being selectively accessible by a plurality of users.

In one embodiment, the method of the present invention comprises: drafting a contract or receiving a draft contract, said contract draft having one or more obligations; storing data obtained from the draft in a single contract database comprising data obtained from multiple contract documents; after execution of said draft, storing data obtained from the resulting contract in said database, said data organized into fields comprising: draft contract status, contract identifier, contract type, effective date, and expiration date; and a field comprising obligation type, status, owner or due date; and said system capable of generating reports based on said database, said reports obtainable through search of said fields and said database being selectively accessible by a plurality of users; and retrieving from said database a report of outstanding obligations.

In another embodiment, the method of the present invention comprises: drafting a contract or receiving a draft contract, said draft contract having one or more obligations; routing the draft contract to one or more parties for review and/or execution; storing review and/or execution data in a single contract database comprising data obtained from multiple contract documents; storing, after execution of said draft, data obtained from the resulting contract in said database said data organized into fields comprising: contract identifier, contract type, contract status, effective date, and expiration date; and a field comprising obligation type, status, owner or due date; and said system capable of generating reports based on said database, said reports obtainable through search of said fields, and said database being selectively accessible by a plurality of users; and retrieving from said database a report of outstanding financial obligations.

In another embodiment, the method of the present invention comprises: drafting a contract or receiving a draft contract, said draft contract having one or more obligations; routing the draft contract to one or more parties for review and/or execution; storing review and/or execution data in a single contract database comprising data obtained from multiple contract documents; storing, after contract execution, data obtained from the resulting contract in said database, said data organized into fields comprising: contract identifier, contract type, contract status, effective date, and expiration date; and a field comprising obligation type, status, owner or due date; and said system capable of generating reports based on said database, said reports obtainable through search of said fields, and said database being selectively accessible by a plurality of users; retrieving from said database a report of outstanding obligations; analyzing said report to determine which, if any, of said obligations should be acted upon; taking action based on said analysis; and updating said database to reflect said action.

In another embodiment, the method of the present invention comprises: drafting a contract or receiving a draft contract, said draft contract proposing to obligate a party to make one or more payments; routing the draft contract to one or more parties for review and/or execution; storing review and/or execution data in a single contract database comprising data obtained from multiple contract documents; storing, after execution of said draft, data obtained from the resulting contract in said database, said data organized into fields comprising: draft contract status, contract identifier, contract type, effective date, expiration date and payment due date; and said system capable of generating reports based on said database, said reports obtainable through search of said fields, and said database being selectively accessible by a plurality of users; retrieving from said database a list of payments due; obtaining from said database an invoice or payment letter wherein said invoice or payment letter is generated automatically using said stored data; and sending the invoice or payment letter.

In another embodiment, the method of the present invention comprises: drafting a contract or receiving a draft contract, said draft contract proposing to obligate a party to make one or more payments; routing the draft contract to one or more parties for review and/or execution; storing review and/or execution data in a single contract database comprising data obtained from multiple contract documents; storing, after execution of said draft, data obtained from the resulting contract in said database, said data comprising payment data; generating from said database a list of payments due; obtaining from said database an invoice or payment letter wherein said invoice or payment letter is generated automatically using the data stored in said database; sending the invoice or payment letter; and updating the database to reflect that payment was made or to reflect receipt of payment.

### BRIEF DESCRIPTION OF THE DRAWINGS

This invention will be better understood with reference to the following drawings and figures, which are intended to illustrate specific embodiments within the overall scope of the invention as claimed.

FIG. 1 is a screen shot showing general agreement detail.

FIG. 2 is a screen shot showing various dates relevant to an agreement.

FIG. 3 is screen shot showing routing/distribution information for an agreement that is in draft form.

FIG. 4 is a screen shot showing data for agreement amendments.

FIG. 5 is a screen shot showing financial obligation detail.

FIG. 6 is a screen shot showing obligation triggering event detail.

FIG. 7 is a screen shot showing obligation triggering event schedule.

FIG. 8 is a screen shot showing invoice schedule. FIG. 9 is a screen shot showing payment schedule.

FIG. 10 is a screen shot showing agreement security information.

FIG. 11 is a screen shot showing obligation summary information.

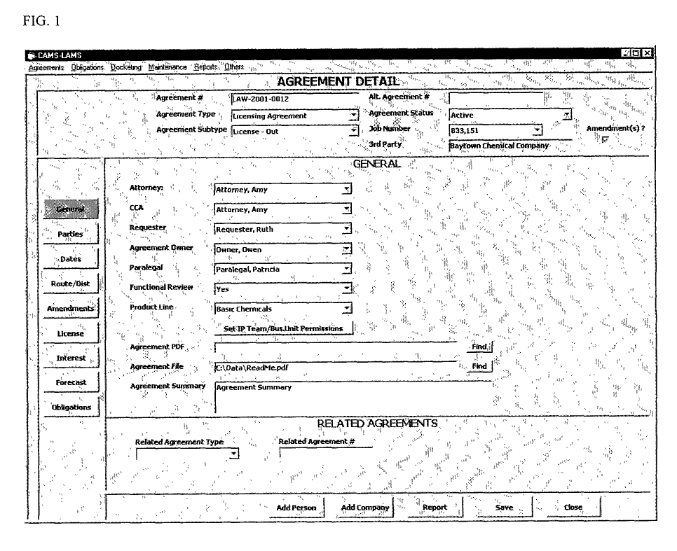

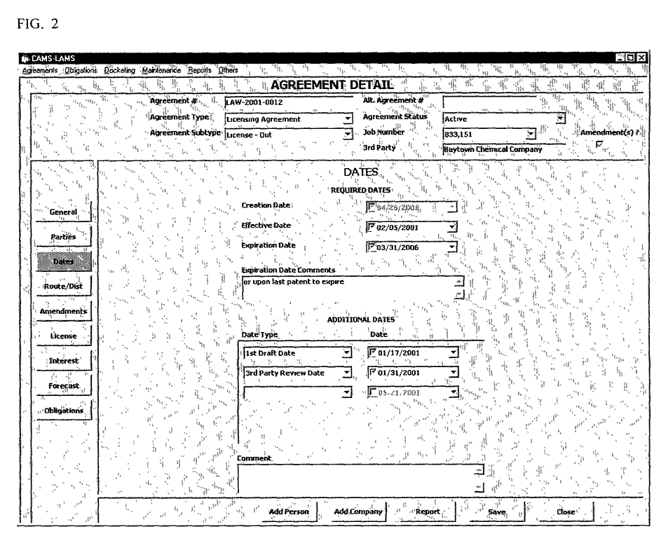

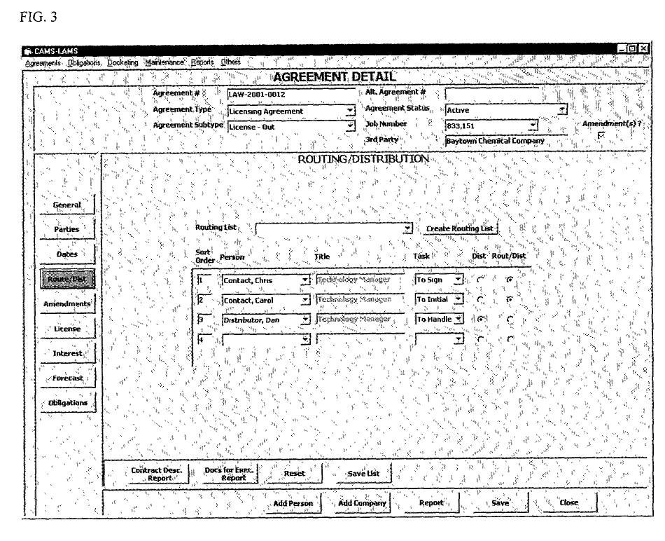

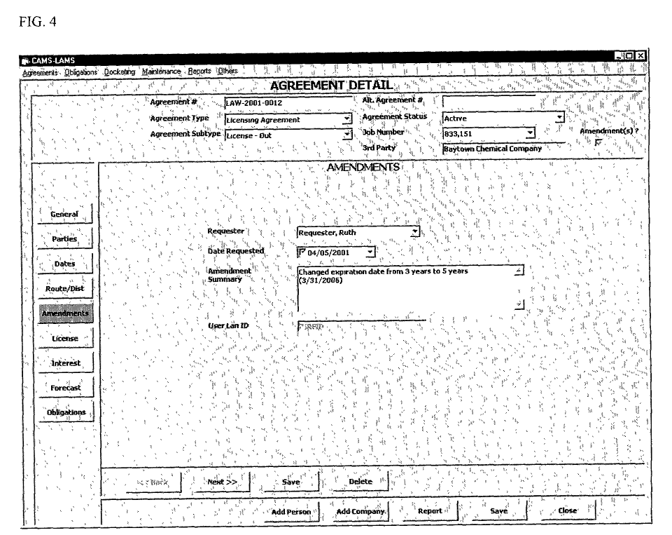

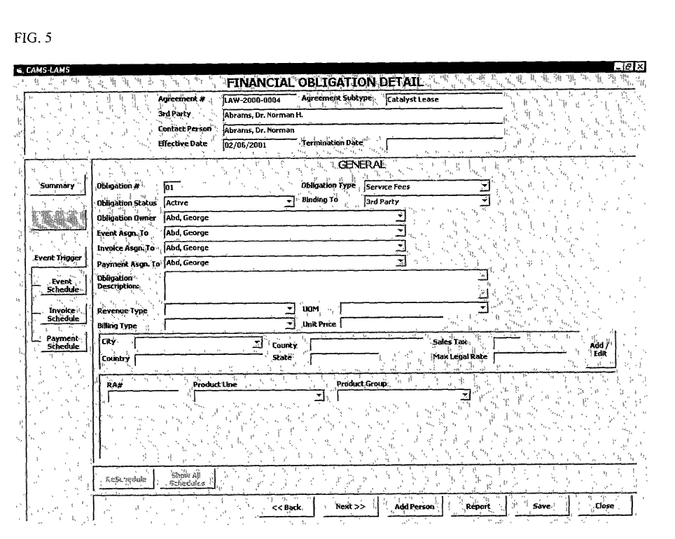

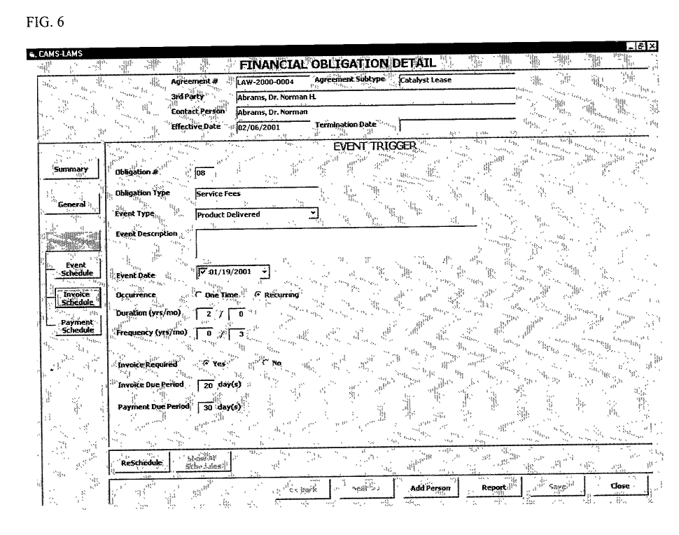

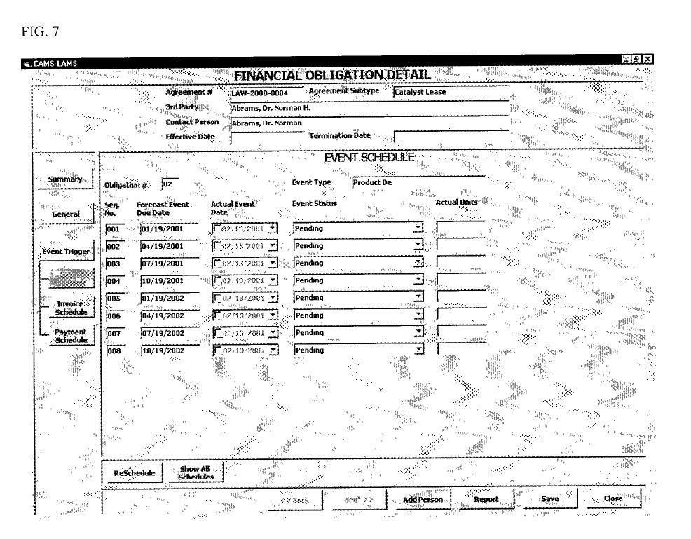

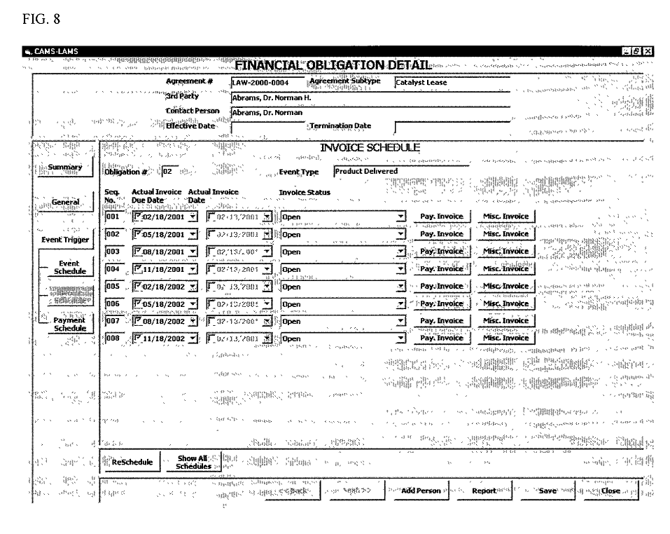

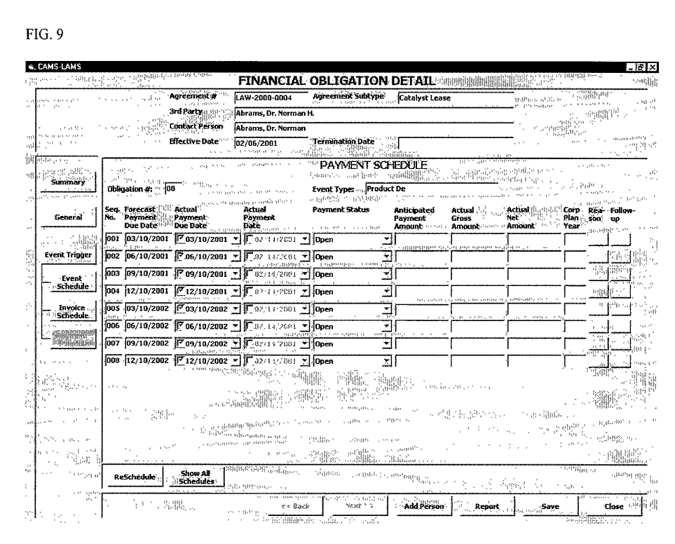

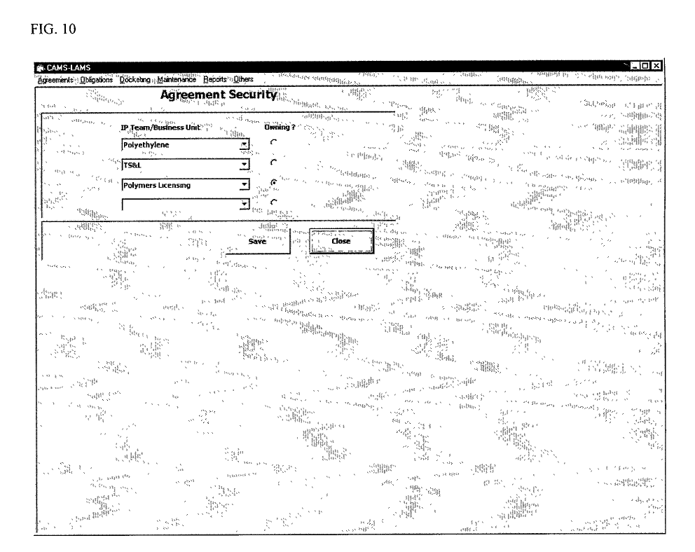

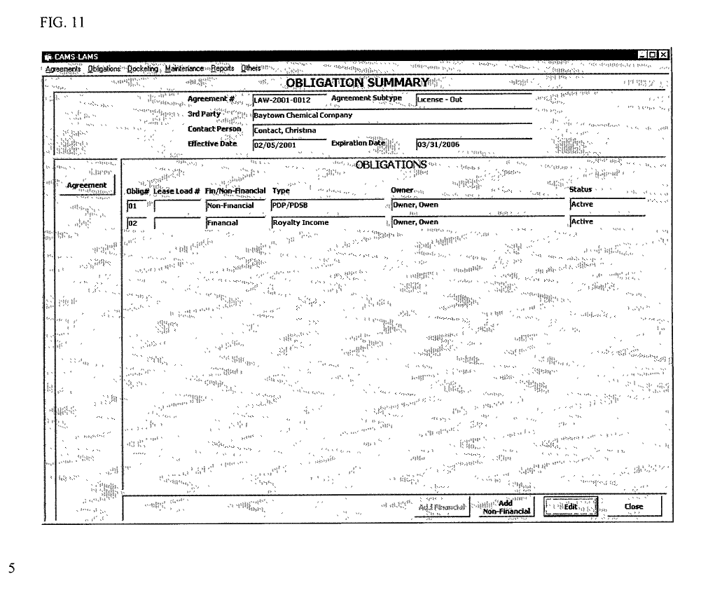

### DETAILED DESCRIPTION OF THE INVENTION

A key component of the present invention is the contract database. As used herein, the term “database” is defined to mean a computerized collection of data organized by fields, records and files to allow rapid access. A field is an area in a fixed or known location in a record; a record is a collection of data items arranged for processing by a program; and a file is a is a related collection of records. Fields for the contract database are described more fully below. In this case, each contract is a record in the database, and each file contains items such as the agreement record along with its linked (scanned in) agreement file, obligations, triggering events, invoices and payments (if any). The database can be relational, distributed, multidimensional or an object-oriented programming database.

As used herein, the terms “contract” and “agreement” are used interchangeably. The term “contract draft” or “draft” refers to a proposed contract, i.e., one that has not yet been executed, signed or otherwise finalized. “Contract document,” as used herein, is defined to include both finalize contracts and contract drafts. “Report” as used herein means a formatted and organized presentation (either electronic or hardcopy) of data retrieved from a table or query. An “obligation triggering event” is any event upon which a contract obligation or right is conditioned. As used herein the term “obligation” includes the term “right.”

The contract database of the present invention may be used for any type of contract document. Examples of suitable contract documents include those relating to all types of goods and services. In one embodiment, the database of the present invention is designed to manage contract documents relating to intellectual property. Examples of such contracts include: patent licenses, trademark licenses, copyright licenses, technology licenses, joint ventures, confidentiality agreements, research agreements, technical assistance agreements, technology or software evaluation agreements, engineering services agreements, technology testing agreements, manufacturing agreements, technology/product leasing agreements, technology/product sales agreements, technology process design agreements, consulting agreements etc. or any combination of the above. The license agreements may be “one-way” or “two-way,” i.e., the intellectual property is transferred by one or both parties to the other. A confidentiality agreement (or obligation) may also be “one-way” or “two-way” (i.e., the obligation of confidentiality is on one party or is mutual), and may include an obligation to return or destroy documentation and/or samples of goods. There may also be an obligation to report evaluation results or use the information and/or sample in a specified manner.

Often the obligations in such intellectual property agreements are conditioned on the occurrence of some other event, an obligation triggering event. The obligation to pay royalties, for example, may be triggered by events such as plant start-up, production of product or sales of product. The obligation to return or destroy documentation and/or samples of goods is often triggered by completion of evaluation or termination of the agreement. In one embodiment of the present invention, the contract database is designed to track specific obligations in relation to their due-dates or corresponding obligation triggering events.

Data relating to each contract document is organized and entered into the database according to predefined fields. Most contracts share certain defining characteristics such as effective date, expiration date and contracting parties. These are of course suitable fields. Examples of other suitable fields are: some sort of “contract identifier,” i.e., either a number or word (such as a party's name) or symbol used to distinguish that contract record from others in the database, agreement type, a field indicating whether or not the draft or contract is in standard form, and a field indicating whether the contract is related to another contract in the database either by its terms, subject matter or business unit, an identifier for the related agreement, and the relationship of the related agreement (e.g., supercedes, sublicense), a field indicating who or what group is responsible for the agreement.

Each field may be subdivided, for example with a “drop-down list,” to prompt the entry of certain details. For example, the “parties” field may be used to store data such as contact names, addresses, phone and fax numbers etc. In one embodiment, advanced table maintenance capability allows users to dynamically add and change selections for drop-down lists and other look-up tables for use in current and future agreements.

The contract database of the present invention includes fields relating to draft contracts and to contract obligations. Examples of such fields include, but are not limited to: draft contract status, obligation type (some short verbal description of the obligation), obligation owner (what person, designated by name or title, is responsible for making sure the obligation is met), obligation status (whether the obligation is still outstanding, being carried out, expired etc.), obligation due date, units of measure, product group, billing number, etc.

The field for draft contract status may be varied or subdivided to indicate when the first and/or subsequent draft was created, who created the draft, who requested the draft, whether the draft is being negotiated, whether the draft is being reviewed and by whom, whether the review is internal or external, whether the draft is being reviewed for execution and by whom etc.

In one embodiment, the database of the present invention also includes fields relating to obligation triggering events. Examples of such fields include, but are not limited to, obligation triggering event type (some short verbal description of the obligation triggering event), obligation triggering event owner (what person, designated by name or title, is responsible for making sure the obligation triggering event is monitored), obligation status (whether the obligation triggering event, is still outstanding, being carried out, or has already been completed etc.), obligation triggering event date, whether the event frequency and/or duration, and whether the whole obligation including event, invoice and payment is recurring or one-time.

It may be particularly useful to link all obligations and obligation triggering events to a responsible person and create fields such as: obligation owner, obligation assigned to, event assigned to, invoice assigned to, payment assigned to, etc.

In one embodiment of the present invention, the fields of the database are used to generate reports that are in turn used to track, manage and administer various contract obligations. Such reports may also include certain calculations using the field data, and they can be used for business forecasting and planning. The reports are either predefined or created as needed.

Optionally, the database can automatically remind designated people of obligations (or obligation triggering events) or important dates, and can interface directly or indirectly with other databases or networks. Examples of other databases include but are not limited to: telephone, e-mail, organizational directories, collections of financial information, patent management systems, standard contract template repositories, or any combination of the above. Examples of networks include but are not limited to: knowledge sharing platforms, portals, web-based systems, joint inter-company contract systems, supply-chain systems, or any combination of the above.

Examples of reports include, but are not limited to reports showing: financial obligations due, invoices sent, outstanding invoices, non-financial obligations due, obligation triggering events scheduled, contracts expiring, obligations expiring, forecasts, accruals, customer history, active agreements, inactive agreements, cancelled agreements, pending agreements, corporate plan, stewardship etc. For example, the “contracts expiring” report can be designed to alert interested parties far in advance of actual expiration dates to allow for sufficient time to negotiate renewal agreements.

The database of the present invention has extensive search capabilities. In one embodiment, there are three main search screens; agreement search, obligation search and docket search. The agreement search screen allows a user to search for agreements based on several fields including but not limited to: agreement number, agreement type, agreement sub-type, agreement summary, product line, intellectual property team, business unit, product group, parties, effective date, expiration date, attorney, paralegal, agreement requester, and agreement owner. An agreement summary is also full-text searchable and allows the user to search using the “and” and “or” Boolean operators. The obligation search screen in this embodiment allows a user to search for obligations or obligation triggering events that meet certain criteria such as belonging to certain agreement types, owner, due date etc using both obligation and agreement fields.

A docket search allows a user to search for individual components of a financial obligation and individual instances from a recurring obligation's schedule. There are several ways to search based on ownership (for example by product line, intellectual property team, business unit, agreement owner, obligation owner, event owner, invoice assigned to, payment assigned to etc.). A user can also search for obligations and triggering events based on status and due dates.

In addition to reporting, the database of the present invention may be used to generate form documents such as invoices and correspondence. Invoicing can be linked to the obligation triggering event so that when the event occurs, the system automatically updates the invoice due date. Then when the invoice is actually generated, the payment due date is automatically updated and entered on the invoice template. For example, if a license agreement requires quarterly royalty payments and the amount of each payment is determined by the number of product pounds produced, then when the royalty payment obligation information is entered into the database, an obligation triggering event, in this case a production report, is specified. The frequency for the report is entered and quarterly due dates are generated automatically. When the production report is received, the invoice due date is set. The payment due date is automatically adjusted and is based on when the invoice is actually generated. The invoice amount is automatically calculated based on the number of units produced as listed in the production report. When payment is received, the database is updated accordingly. Thus, invoicing can be done directly from the system. Invoices are actually stored in the system and the invoice fields are used in reports.

The database may in one embodiment automatically calculate certain financial terms such as interest, inflation, depreciation, taxes, currency conversions, add-on charges (for example for inspection or shipping) etc. Form documents include: form draft clauses or agreements, forms (for example summarizing the agreement and/or listing various reviewers) used for routing draft agreements for review and/or execution, form correspondence reminding parties or responsible persons of obligations (to make payment for example), form correspondence for renewing agreements, dunning letters etc.

In one embodiment, the database tracks invoice and payment data. This then enables businesses to forecast and report income on a business unit level, and enables financial planning on an agreement by agreement basis including multiple corporate or business plan years, forecasted and actual revenue per agreement or business unit and outlook for each year. The system also enables a business unit to perform stewardship by using reports to total income across all of their agreements and then to compare planned income vs. actual income received.

The database of the present invention may optionally include features such as links to scanned documents (actual agreements and forms for example), large text fields for detailed notes, links to websites, webpages and e-mail addresses, the ability to track and store changes made in various fields, and the ability to store and update financial amounts in multiple types of currency using, for example, online linkage to exchange rates.

In one embodiment, the database of the present invention is designed so that each contract document is accessible by defined users. The users may be grouped such as by job, title, authority, business unit and/or project. In a preferred embodiment, the security is truly back-end so that people using the system have individual access to defined “views.” (“Views” are the records that users are permitted to see.) Write access is selectively granted using stored procedures on the database back end. Groups of users are granted access (view and/or write access) only to records relevant to their business. The database stores what business unit a user is in and all reports, queries and tables are accessed through the correct view. Thus users can create and update data solely in that portion of the database to which they have access.

The methods of the present invention comprise at least the steps of drafting a contract or receiving a draft contract, storing data obtained from the draft in the contract database, after execution of the draft, storing data obtained from the resulting contract in the same database, and retrieving or generating from the database a report of the contract's outstanding obligations.

The drafting step may be as simple as entering basic information into the database, or some other database or form. The first “storing” step requires that at least one bit of information from the draft, for example the parties' names, be logged into the database of the present invention. Typically other items will be entered at this time. For example, the attorney drafting the agreement or responsible for initially reviewing the draft proposed by the other party, the effective and expiration dates, the type of contract or draft status, ownership of the agreement and security for the agreement record etc. During this stage of the contract lifecycle, the database may be updated to reflect that routing/reviews have been conducted or modifications have been made.

After the draft contract is executed by all parties, more detailed information will be entered into the database, for example, specific licensing information, financial terms, forecasting of revenues and information relating to obligations. The report may be generated either automatically or using a unique field search and the report may or may not be printed. As discussed above, reports are used to manage the database contracts and their obligations, therefore, they are typically analyzed for decision making purposes. This analysis may be done automatically, for example using software that interfaces with the database. Likewise the “decision making” and any action taken as a result, may be done automatically, for example by automatically generating (and perhaps sending) an invoice. Once obligations are met (or not), the database can be updated (again, this can be done automatically), for example, to reflect what action was taken and whether other obligations remain outstanding.

Once all of an agreement's obligations are met or have expired, the database is updated (either manually or automatically) to reflect that the agreement has expired. At that time, the agreement record can be archived or set for archive at a later date. Reports can be generated to remind interested parties that the agreement is set to expire so that it may be renewed if necessary. Form letters or memos can be created and generated to facilitate this process.

Having now fully described this invention, it will be appreciated by those skilled in the art that the invention can be performed within a wide range of parameters within what is claimed, without departing from the spirit and scope of the invention. In particular, while this invention has been found to be particularly useful for intellectual property agreements, it is also obviously useful for all types of agreements concerning all types of goods and services.

What is claimed is:

1. A contract generation and administration system comprising: a single contract database comprising data obtained from multiple contract documents, said data organized into fields comprising: draft contract status, contract identifier, contract type, effective date, and expiration date; and a field comprising obligation type, owner, status or due date; said system capable of generating reports based on said database, said reports obtainable through search of said fields; and said database being selectively accessible by a plurality of users.

2. The system of claim 1 wherein the contract documents are selected from the group consisting of: confidentiality contracts, software licenses, technology licenses, lease contracts and service contracts.

3. The system of claim 1 wherein the contract documents are licenses.

4. The system of claim 1 wherein said fields further comprise at least one of those selected from the group consisting of: obligation triggering event, royalty basis, invoice due date, payment due date, payment received date, payment schedule, tax, currency and invoice status.

5. The system of claim 1 wherein said draft contract status field indicates whether a contract document is being reviewed and/or executed.

6. The system of claim 1 wherein said obligation type field is substantially defined as training, meeting, shipping, payment, receipt of payment, reporting, start-up, secrecy, restricted use, maintenance or technology transfer.

7. The system of claim 1 wherein a user's access to one or more parts of said database is based on contract type, user's job description, user's title, user's business unit, and/or user's authority level.

8. The system of claim 1 wherein said reports are selected from the group consisting of: accrued revenue, obligations due, obligations owed, customer history, open invoice, depreciation, corporate plan, stewardship, implementation plan, payments requiring invoice, anticipated payments, audit, pending contracts, active contracts and expiring contracts.

9. The system of claim 1 wherein said database further comprises standard contract forms or clauses.

10. The system of claim 1 wherein said database further comprises standard invoice forms or standard correspondence.

11. The system of claim 1 wherein said database is capable of using its data to generate invoices and correspondence.

12. A contract generation and administration method comprising:
drafting a contract or receiving a draft contract, said contract draft having one or more obligations;
storing data obtained from the draft in a single contract database comprising data obtained from multiple contract documents;
after execution of said draft, storing data obtained from the resulting contract in said database, said data organized into fields comprising: draft contract status, contract identifier, contract type, effective date, and expiration date; and a field comprising obligation type, status, owner or due date; and said database capable of generating reports based on said data, said reports obtainable through search of said fields; and said database being selectively accessible by a plurality of users; and
retrieving from said database a report of outstanding obligations.

13. The method of claim 12 further comprising the step of analyzing said report to determine which, if any, of said obligations should be acted upon.

14. The method of claim 13 further comprising the step of deciding, based on said analysis, whether to act upon one or more of said obligations.

15. The method of claim 13 further comprising the step of taking action based on said analysis.

16. The method of claim 12 further comprising the step of taking action based on an analysis of said report and updating said database to reflect said action.

17. The method of claim 12 further comprising the step of routing the contract draft to one or more parties for review and/or execution.

18. The method of claim 17 further comprising the step of storing review or execution data in the contract database.

19. The method of claim 12 wherein the draft is selected from the group consisting of: draft confidentiality contracts, draft software licenses, draft technology licenses and draft service contracts.

20. The method of claim 12 wherein the draft is a draft license contract.

21. The method of claim 12 wherein the report is organized by obligation status, type, owner, or due date.

22. The method of claim 12 wherein the report lists outstanding financial obligations.

23. The method of claim 12 wherein said fields further comprise at least one of those selected from the group consisting of: obligation triggering event, royalty basis, invoice due date, payment due date, payment received date, payment schedule, tax, currency and invoice status.

24. The method of claim 12 wherein a user's access to one or more parts of said database is based on contract type, user's job description, user's title, user's business unit, and/or user's authority level.

25. The method of claim 12 wherein said contract database is used to indicate whether a contract document is being reviewed and/or executed.

26. The method of claim 12 wherein said database further comprises standard contract forms or clauses.

27. The method of claim 12 wherein said database further comprises standard invoice forms or standard correspondence.

28. The method of claim 12 further comprising the step of storing the invoice in the database.

29. A contract generation and administration method comprising:
drafting a contract or receiving a draft contract, said draft contract having one or more obligations;
routing the draft contract to one or more parties for review and/or execution;
storing review and/or execution data in a single contract database comprising data obtained from multiple contract documents;
storing, after execution of said draft, data obtained from the resulting contract in said database said data organized into fields comprising: draft contract status, contract identifier, contract type, effective date, and expiration date; and a field comprising obligation type, status, owner or due date; and said database capable of generating reports based on said data, said reports obtainable through search of said fields, and said database being selectively accessible by a plurality of users; and
retrieving from said database a report of outstanding financial obligations.

30. The method of claim 29 further comprising the step of analyzing said report to determine which, if any, of said obligations should be acted upon.

31. The method of claim 30 further comprising the step of deciding, based on said analysis, whether to act upon one or more of said financial obligations.

32. The method of claim 30 further comprising the step of either making or receiving payment based on said analysis.

33. The method of claim 32 further comprising the step of updating said database to reflect said payment or receipt of payment.

34. The method of claim 29 wherein the draft is selected from the group consisting of: draft confidentiality contracts, draft software licenses, draft technology licenses and draft service contracts.

35. The method of claim 29 wherein the draft is a draft license contract.

36. The method of claim 29 wherein the report indicates obligation status, type, owner and/or due date.

37. The method of claim 29 wherein said fields further comprise at least one of those selected from the group consisting of: obligation triggering event, royalty basis, invoice due date, payment due date, payment received date, payment schedule, tax, currency and invoice status.

38. The method of claim 29 wherein said contract database is used to indicate whether a contract document is being reviewed and/or executed.

39. The method of claim 29 wherein a user's access to one or more parts of said database is based on contract type, user's job description, user's title, user's business unit and/or user's authority level.

40. The method of claim 29 wherein said database further comprises standard contract forms or clauses.

41. The method of claim 29 wherein said database further comprises standard invoice forms or standard correspondence.

42. The method of claim 29 further comprising the step of obtaining an invoice generated automatically from said database.

43. A contract generation and administration method comprising:
drafting a contract or receiving a draft contract, said draft contract having one or more obligations;
routing the draft contract to one or more for review and/or execution;
storing review and/or execution data in a single contract database comprising data obtained from multiple contract documents;
storing, after contract execution, data obtained from the resulting contract in said database, said data organized into fields comprising: draft contract status, contract identifier, contract type, effective date, and expiration date;
and a field comprising obligation type, status, owner or due date; and said system capable of generating reports based on said database, said reports obtainable through search of said fields, and said database being selectively accessible by a plurality of users;
retrieving from said database a report of outstanding obligations;
analyzing said report to determine which, if any, of said obligations should be acted upon;
taking action based on said analysis; and
updating said database to reflect said action.

44. The method of claim 43 wherein the draft is selected from the group consisting of: draft confidentiality contracts, draft software licenses, draft technology licenses and draft service contracts.

45. The method of claim 43 wherein the draft is a draft license.

46. The method of claim 43 wherein said obligations are financial obligations.

47. The method of claim 43 wherein the report is organized by obligation status, type, owner and/or due date.

48. The method of claim 43 wherein said fields further comprise at least one of those selected from the group consisting of: obligation triggering event, royalty basis, invoice due date, payment due date, payment received date, payment schedule, tax, currency and invoice status.

49. The method of claim 43 wherein said contract database is used to indicate whether a contract document is being reviewed and/or executed.

50. The method of claim 43 wherein a user's access to one or more parts of said database is based on contract type, user's job description, user's title, user's business unit and/or user's authority level.

51. The method of claim 43 wherein said database further comprises standard contract forms or clauses.

52. The method of claim 43 wherein said database further comprises standard invoice forms or standard correspondence.

53. The method of claim 43 further comprising the step of obtaining an invoice generated automatically from said database.

54. A contract generation and administration method comprising:
drafting a contract or receiving a draft contract, said draft contract proposing to obligate a party to make one or more payments;
routing the draft contract to one or more parties for review and/or execution;
storing review and/or execution data in a single contract database comprising data obtained from multiple contract documents;
storing, after execution of said draft, data obtained from the resulting contract in said database, said data organized into fields comprising: draft contract status, contract identifier, contract type, effective date, expiration date and payment due date; and said database capable of generating reports based on said data, said reports obtainable through search of said fields, and said database being selectively accessible by a plurality of users;
retrieving from said database a list of payments due;
obtaining from said database an invoice or payment letter wherein said invoice or payment letter is generated automatically using said stored data; and
sending the invoice or payment letter.

55. The method of claim 54 wherein said fields further comprise at least one of those selected from the group consisting of: obligation triggering event, royalty basis, invoice due date, payment due date, payment received date, payment schedule, tax, currency and invoice status.

56. The method of claim 54 wherein said contract database is used to indicate whether a contract document is being reviewed and/or executed.

57. The method of claim 54 wherein a user's access to one or more parts of said database is based on contract type, user's job description, user's title, user's business unit, and/or user's authority level.

58. The method of claim 54 wherein said database further comprises standard contract forms or clauses.

59. The method of claim 54 wherein said database further comprises standard invoice forms or standard correspondence.

60. The method of claim 54 further comprising the step of updating the database to reflect that payment was made or to reflect receipt of payment.

61. The method of claim 54 wherein the draft is a draft license contract.

62. A contract generation and administration method comprising:
drafting a contract or receiving a draft contract, said draft contract proposing to obligate a party to make one or more payments;
routing the draft contract to one or more parties for review and/or execution;
storing review and/or execution data in a single contract database comprising data obtained from multiple contract documents;
storing, after execution of said draft, data obtained from the resulting contract in said database, said data comprising payment data;
generating from said database a list of payments due;
obtaining from said database an invoice or payment letter wherein said invoice or payment letter is generated automatically using the data stored in said database;
sending the invoice or payment letter; and
updating the database to reflect that payment was made or to reflect receipt of payment.

63. The method of claim 62 wherein said data is organized into fields comprising: draft contract status, contract identifier, contract type, effective date, expiration date and payment due date; and said database capable of generating reports based on said data, said reports obtainable through search of said fields, and said database being selectively accessible by a plurality of users.

64. The method of claim 62 wherein said contract database is used to indicate whether a contract document is being reviewed and/or executed.

65. The method of claim 62 wherein said fields further comprise at least one of those selected from the group consisting of: obligation triggering event, royalty basis, invoice due date, payment due date, payment received date, payment schedule, tax, currency and invoice status.

66. The method of claim 62 wherein a user's access to one or more parts of said database is based on contract type, user's job description, user's title, user's business unit, and/or user's authority level.

67. The method of claim 62 wherein said database further comprises standard contract forms or clauses.

68. The method of claim 62 wherein said database further comprises standard invoice forms or standard correspondence.

69. A contract generation and administration method comprising:
drafting a contract or receiving a draft contract, said draft contract proposing to obligate a party to make one or more payments;
routing the draft contract to one or more parties for review and/or execution;
storing review and/or execution data in a single contract database comprising data obtained from multiple contract documents;
obtaining from the database an indication as to whether the draft is being reviewed and/or executed.
storing, after execution of said draft, data obtained from the resulting contract in said database, said data comprising payment triggering event data; and
generating from said database a report of payment triggering events.

70. The method of claim 69 further comprising the step of analyzing said report and deciding to make payment based on said analysis.

71. The method of claim 69 further comprising the step of obtaining from said database a payment letter generated automatically using the data stored in said database.

72. The method of claim 69 further comprising the steps of sending the payment letter and updating the database to reflect that payment was made.

73. The method of claim 69 wherein said data is organized into multiple fields comprising: draft contract status, contract identifier, contract type, effective date, expiration date and payment due date; and said database capable of generating reports based on said data, said reports obtainable through search of said fields, and said database being selectively accessible by a plurality of users.

74. The method of claim 73 wherein said fields further comprise at least one of those selected from the group consisting of: obligation triggering event, royalty basis, invoice due date, payment due date, payment received date, payment schedule, tax, currency and invoice status.

75. The method of claim 69 wherein a user's access to one or more parts of said database is based on contract type, user's job description, user's title, user's business unit, and/or user's authority level.

76. A contract generation and administration method comprising:
drafting a contract or receiving a draft contract, said draft contract proposing to obligate a party to make one or more payments;
routing the draft contract to one or more parties for review and/or execution;
storing review and/or execution data in a single contract database comprising data obtained from multiple contract documents;
obtaining from the database an indication as to whether the draft is being reviewed and/or executed. storing, after execution of said draft, data obtained from the resulting contract in said database, said data comprising payment triggering event data;
generating from said database a report of payment triggering events;
analyzing the report to determine whether payment should be made;
making payment; and
updating the database to reflect that payment was made.
